(19) United States
(12) Patent Application Publication
(10) Pub. No.: US 2026/0250459 A1
(43) Pub. Date: Aug. 27, 2026

(54) PREPREG, FIBER-REINFORCED COMPOSITE MATERIAL, TUBULAR BODY MADE OF FIBER-REINFORCED COMPOSITE MATERIAL, GOLF CLUB SHAFT, AND FISHING ROD

(71) Applicant: TORAY INDUSTRIES, INC., Tokyo (JP)

(72) Inventors: Yasuyuki OMMURA, Iyo-gun (JP); Masanori HIRANO, Iyo-gun (JP); Kentaro SANO, Iyo-gun (JP)

(73) Assignee: TORAY INDUSTRIES, INC., Tokyo (JP)

(21) Appl. No.: 18/879,509

(22) PCT Filed: Jun. 27, 2023
(86) PCT No.: PCT/JP2023/023765

§ 371 Date: Dec. 27, 2024

(30) Foreign Application Priority Data
Aug. 2, 2022 (JP) 2022-123191

(51) Int. Cl. C08G 59/38; A01K 87/00; A63B 53/10; C08G 59/24; C08G 59/32; C08G 59/36; C08G 59/68; C08J 5/24

(52) U.S. Cl. CPC C08G 59/38; A01K 87/00; A63B 53/10; C08G 59/245; C08G 59/3218; C08G 59/36; C08G 59/686; C08J 5/24; A63B 2209/023; C08J 2363/04

(57) ABSTRACT

An object of the present invention is to provide a prepreg containing a resin composition which has an excellent elastic modulus and heat resistance, and which also has an excellent appearance including weather resistance and transparency, as well as to provide a fiber-reinforced composite material, a tubular fiber-reinforced composite material, a golf club shaft and a fishing rod, using the prepreg, and having excellent mechanical properties, heat resistance and appearance. As means to achieve the above-mentioned object, the present invention provides a prepreg including reinforcing fibers and a resin composition, wherein the resin composition contains the following component [A] to component [D]: component [A]: a novolac type epoxy resin; component [B]: an oxazolidone type epoxy resin; component [C]: one or both of a sorbitol type epoxy resin and a glycerol type epoxy resin; and component [D]: dicyandiamide; and wherein the resin composition satisfies the following requirement (1) to requirement (5): requirement (1): the content of the component [A] is from 20 to 50 parts by mass, with respect to 100 parts by mass of the total epoxy resin; requirement (2): the content of the component [B] is from 10 to 40 parts by mass, with respect to 100 parts by mass of the total epoxy resin; requirement (3): the content of the component [C] is from 10 to 40 parts by mass, with respect to 100 parts by mass of the total epoxy resin; requirement (4): the resin composition contains a total of 40 parts by mass or more of the component [B] and the component [C], in 100 parts by mass of the total epoxy resin; and requirement (5): the resin composition does not contain a component [E] which is a glycidylamine type epoxy resin, or in cases where the resin composition contains the component [E], the content thereof is 10 parts by mass or less with respect to 100 parts by mass of the total epoxy resin.

### TECHNICAL FIELD

The present invention relates to a prepreg, a fiber-reinforced composite material and a tubular fiber-reinforced composite material, which are suitably used in fiber-reinforced composite materials for aerospace applications, general industrial applications, sports applications and the like. The present invention also relates to a golf club shaft and a fishing rod using the tubular fiber-reinforced composite material.

### BACKGROUND ART

Fiber-reinforced composite materials using carbon fibers, aramid fibers or the like as reinforcing fibers are widely used in structural materials for aircrafts, automobiles and the like, as well as sports and general industrial applications, such as tennis rackets, golf club shafts, fishing rods, bicycles, casings, and the like, utilizing their high specific strength and specific modulus. Thermosetting resins are mainly used in resin compositions for use in such fiber-reinforced composite materials, from the viewpoints of heat resistance and productivity. Above all, epoxy resins are preferably used from the viewpoint of mechanical properties, such as adhesion to reinforcing fibers.

There is a growing demand for improvements in various physical properties, in recent years, in order to use fiber-reinforced composite materials in applications such as golf club shafts, fishing rods and bicycles, for which further reduction in weight is demanded. To achieve an excellent flexural strength in a tubular body such as a golf club shaft or a fishing rod, for example, the fiber-reinforced composite material to be used for the tubular body is required to have a high strength in the fiber direction and in the non-fiber direction. However, such a strength is greatly affected by the strength and the elastic modulus of an epoxy resin itself to be used as a matrix resin. Further, the fiber-reinforced composite material is also required to have a high heat resistance capable of withstanding the processing heat during the processing of the composite material into a final product. In addition, there are increasing number of cases in which the surface of a fiber-reinforced composite material is coated with a clear coating, and the cross pattern or the like of the reinforcing fibers is used as a design. Therefore, there is a growing tendency to place a greater importance on the appearance including the weather resistance and the transparency, of a cured product of the epoxy resin to be used as a matrix resin, as well, in addition to the fact that the cured product shows excellent mechanical properties and heat resistance.

Patent Literature 1 examines a composition containing an oxazolidone type epoxy resin and a novolac type epoxy resin, because such a composition can achieve both the mechanical properties and the heat resistance in a balanced manner. Further, Patent Literature 2 examines a prepreg which has no cloudiness due to moisture absorption and which allows the resulting fiber-reinforced composite material to have an excellent appearance, by using an epoxy resin composition having a parallel light transmittance of 30% or more. In addition, Patent Literature 3 examines a towpreg which contains a dissolution enhancer, such as a sorbitol type epoxy resin, in order to reduce the situation where dicyandiamide used as a curing agent remains without being completely dissolved to cause defects, and in which the resin composition used therein has an excellent fracture strain and degree of transparency.

### CITATION LIST

### Patent Literatures

Patent Literature 1: WO 2020/080474
Patent Literature 2: JP 2003-261744 A
Patent Literature 3: JP 2020-158594 A

### SUMMARY OF INVENTION

### Technical Problem

The use of the technique disclosed in Patent Literature 1 enables to achieve both the elastic modulus and the heat resistance in a balanced manner. However, no consideration is given to the appearance including weather resistance and transparency in Patent Literature 1, and an excellent appearance could not be stably obtained. The use of the use of the technique disclosed in Patent Literature 2 enables to obtain a resin cured product having an excellent transparency, or a molded article without cloudiness due to moisture absorption. However, the resin cured product has a low elastic modulus, and the resulting fiber-reinforced composite material does not necessarily have excellent mechanical properties. Further, no consideration is given to the weather resistance in Patent Literature 2, and there is room for improvement in the weather resistance, as well. In Patent Literature 3, while a resin cured product having an excellent transparency can be obtained, the resin cured product has a low elastic modulus and heat resistance, and the resulting fiber-reinforced composite material does not necessarily have excellent mechanical properties and heat resistance. Further, no consideration is given to the weather resistance, also in Patent Literature 3, and an excellent weather resistance could not be stably obtained.

Accordingly, an object of the present invention is to provide a prepreg containing a resin composition which has an excellent elastic modulus and heat resistance, and which also has an excellent appearance including weather resistance and transparency, as well as to provide a fiber-reinforced composite material, a tubular fiber-reinforced composite material, a golf club shaft and a fishing rod, using the prepreg, and having excellent mechanical properties, heat resistance and appearance.

### Solution to Problem

1. A prepreg including reinforcing fibers and a resin composition,
   wherein the resin composition contains the following component [A] to component [D]:
      component [A]: a novolac type epoxy resin;
      component [B]: an oxazolidone type epoxy resin;
      component [C]: one or both of a sorbitol type epoxy resin and a glycerol type epoxy resin; and
      component [D]: dicyandiamide; and
   wherein the resin composition satisfies the following requirement (1) to requirement (5):
      requirement (1): the content of the component [A] is from 20 to 50 parts by mass, with respect to 100 parts by mass of the total epoxy resin;
      requirement (2): the content of the component [B] is from 10 to 40 parts by mass, with respect to 100 parts by mass of the total epoxy resin;
      requirement (3): the content of the component [C] is from 10 to 40 parts by mass, with respect to 100 parts by mass of the total epoxy resin;
      requirement (4): the resin composition contains a total of 40 parts by mass or more of the component [B] and the component [C], in 100 parts by mass of the total epoxy resin; and
      requirement (5): the resin composition does not contain a component [E] which is a glycidylamine type epoxy resin, or in cases where the resin composition contains the component [E], the content thereof is 10 parts by mass or less with respect to 100 parts by mass of the total epoxy resin.
2. The prepreg according to 1 described above, wherein the resin composition does not contain the component [E], or in cases where the resin composition contains the component [E], the content thereof is 1 part by mass or less with respect to 100 parts by mass of the total epoxy resin.
3. The prepreg according to 1 or 2 described above, wherein the resin composition further contains a component [F] which is a compound that has a boiling point of 130° C. or higher and a molecular weight m of 50 or more and 250 or less, that does not contain an epoxy group within the molecule, and that does not have an epoxy resin curing ability.
4. The prepreg according to any one of 1 to 3 described above, wherein the resin composition contains a component [G] which is a phenoxy resin, as a thermoplastic resin.
5. A fiber-reinforced composite material, obtained by curing the prepreg according to any one of 1 to 4 described above.
6. A tubular fiber-reinforced composite material, obtained by molding the prepreg according to any one of 1 to 4 described above.
7. A golf club shaft using the tubular fiber-reinforced composite material according to 6 described above.
8. A fishing rod using the tubular fiber-reinforced composite material according to 6 described above.

### Advantageous Effects of Invention

The present invention enables to provide a prepreg containing a resin composition which has an excellent elastic modulus and heat resistance, and which also has an excellent appearance including weather resistance and transparency, as well as to provide a fiber-reinforced composite material, a tubular fiber-reinforced composite material, a golf club shaft and a fishing rod, using the prepreg, and having excellent mechanical properties, heat resistance and appearance.

### DESCRIPTION OF EMBODIMENTS

The present invention will be described below in detail.

The prepreg according to the present invention contains a resin composition and reinforcing fibers. The prepreg is preferably composed of a resin composition and reinforcing fibers. The resin composition contains component [A] to component [D] as essential components.

The component [A] in the present invention is a novolac type epoxy resin. When the resin composition contains the component [A], the elastic modulus and the heat resistance of the resulting resin cured product can be improved without impairing the weather resistance, making it possible to obtain a fiber-reinforced composite material having excellent mechanical properties, heat resistance and appearance.

It is necessary that the resin composition contain from 20 to 50 parts by mass of the component [A], with respect to 100 parts by mass of the total epoxy resin contained in the resin composition. The lower limit of the content of the component [A] is preferably 25 parts by mass or more, and more preferably 30 parts by mass or more. The upper limit thereof is preferably 45 parts by mass or less, and more preferably 40 parts by mass or less. When resin composition contains the component [A] within the range described above, the resulting resin cured product has an excellent transparency, and has a good balance between the mechanical properties, the heat resistance and the appearance.

Further, in order to obtain a resin cured product having a good balance between the flexural elastic modulus and the heat resistance, the lower limit of the softening point of the novolac type epoxy resin is preferably 50° C. or higher, and more preferably 60° C. or higher. The upper limit of the softening point described above is preferably 120° C. or lower, and more preferably 110° C. or lower.

The component [A] may be, for example, a phenol novolac type epoxy resin or a cresol novolac type epoxy resin.

Examples of commercially available products of the phenol novolac type epoxy resin include: “jER (registered trademark)” 152 and 154 (both manufactured by Mitsubishi Chemical Corporation); EPPN-201 (manufactured by Nippon Kayaku Co., Ltd.); and “EPICLON (registered trademark)” N-740, N-770 (softening point: 70° C.) and N-775 (softening point: 75° C., all of the above manufactured by DIC Corporation).

Examples of commercially available products of the cresol novolac type epoxy resin include “EPICLON (registered trademark)” N-660 (softening point: from 66° C.), N-665 (softening point: from 70° C.), N-670 (softening point: from 73° C.), N-673 (softening point: from 78° C.), N-680 (softening point: from 87° C.), N-690 (softening point: from 93° C.) and N-695 (softening point: from 95° C.; all of the above manufactured by DIC Corporation).

The component [B] in the present invention is an oxazolidone type epoxy resin. When the resin composition contains the component [B], the heat resistance of the resulting resin cured product can be improved without impairing the weather resistance. Further, when the resin composition contains the component [B], it is possible to accelerate the dissolution of dicyandiamide as the component [D], and to improve the transparency of the resin cured product. That is, the incorporation of the component [B] allows for obtaining a fiber-reinforced composite material having an excellent heat resistance and appearance.

It is necessary that the resin composition contain from 10 to 40 parts by mass of the component [B], with respect to 100 parts by mass of the total epoxy resin contained in the resin composition. The lower limit of the content of the component [B] is preferably 15 parts by mass or more, and more preferably 20 parts by mass or more. The upper limit thereof is preferably 35 parts by mass or less, and more preferably 30 parts by mass or less. When the content of the component [B] is equal to or higher than the lower limit value described above, the resulting resin cured product has an excellent heat resistance and transparency, and when the content thereof is equal to or lower than the upper limit value described above, the flexural elastic modulus of the resin cured product will not be impaired. That is, the incorporation of the component [B] within the range described above allows the resulting resin cured product to have a good balance between the transparency, the heat resistance and the flexural elastic modulus.

Examples of commercially available products of the component [B] which can be used include: AER 4152 and AER 4151 (both manufactured by Asahi Kasei E-Materials Corporation); “D. E. R. (registered trademark)” 852 and 858 (both manufactured by The Dow Chemical Company); TSR-400 (manufactured by DIC Corporation); and ACR 1348 (manufactured by ADEKA Corporation).

The component [C] in the present invention is one or both of a sorbitol type epoxy resin and a glycerol type epoxy resin. In cases where the resin composition contains both a sorbitol type epoxy resin and a glycerol type epoxy resin, both types of epoxy resins are collectively defined as the component [C]. These resins may be used singly, or both types of epoxy resins may be used in combination. When the rein composition contains the component [C], the flexural elastic modulus of the resulting resin cured product can be improved without impairing the weather resistance. Further, since the component [C] has a high polarity due to containing a hydroxyl group within the molecular structure, it is possible to accelerate the dissolution of dicyandiamide as the component [D], and to improve the transparency of the resin cured product. That is, the incorporation of the component [C] allows for obtaining a fiber-reinforced composite material having an excellent flexural elastic modulus and appearance.

It is necessary that the resin composition contain from 10 to 40 parts by mass of the component [C], with respect to 100 parts by mass of the total epoxy resin contained in the resin composition. The lower limit of the content of the component [C] is preferably 15 parts by mass or more, and more preferably 20 parts by mass or more. The upper limit thereof is preferably 35 parts by mass or less, and more preferably 30 parts by mass or less. When the content of the component [C] is equal to or higher than the lower limit value described above, the resulting resin cured product has an excellent flexural elastic modulus and transparency, and when the content is equal to or lower than the upper limit value described above, the heat resistance of the resin cured product will not be impaired. That is, the incorporation of the component [C] within the range described above allows the resulting resin cured product to have a good balance between the transparency, the heat resistance and the flexural elastic modulus.

The glycerol type epoxy resin as the component [C] may be, for example, a monoglycerol type epoxy resin, a diglycerol type epoxy resin or a polyglycerol type epoxy resin.

Examples of commercially available products of the sorbitol type epoxy resin include “DENACOL (registered trademark)” EX-612, EX-614, EX-614B and EX-622 (all of the above, manufactured by Nagase ChemteX Corporation).

Examples of commercially available products of the glycerol type epoxy resin include “DENACOL (registered trademark)” EX-313 and EX-314 (both manufactured by Nagase ChemteX Corporation). Examples of commercially available products of the diglycerol type epoxy resin include “DENACOL (registered trademark)” EX-421 (manufactured by Nagase ChemteX Corporation). Examples of commercially available products of the polyglycerol type epoxy resin include “DENACOL (registered trademark)” EX-512 and EX-521 (both manufactured by Nagase ChemteX Corporation).

As the requirement (4) in the present invention, it is necessary that the total content of the component [B] and the component [C] be 40 parts by mass or more, with respect to 100 parts by mass of the total epoxy resin. The lower limit of the total content described above is preferably 45 parts by mass or more, and more preferably 50 parts by mass or more. The upper limit thereof is 80 parts by mass or less, which is the total of the upper limits of the respective components in the requirement (2) and the requirement (3), but is preferably 70 parts by mass or less, and more preferably 60 parts by mass or less. When the total content of the component [B] and the component [C] with respect to 100 parts by mass of the total epoxy resin is adjusted within the range described above, the transparency of the resulting resin cured product is drastically improved, making it possible to obtain a fiber-reinforced composite material having an excellent appearance (with less cloudiness).

As the requirement (5) in the present invention, it is necessary that the resin composition do not contain a glycidylamine type epoxy resin as a component [E], or in cases where the resin composition contains the component [E], the content thereof is 10 parts by mass or less with respect to 100 parts by mass of the total epoxy resin. Further, in cases where the resin composition contains the component [E], the content thereof is more preferably 5 parts by mass or less, and still more preferably 1 part by mass or less. When the amount of the component [E] to be incorporated is adjusted to 10 parts by mass or less, an improvement in the weather resistance of the resulting resin cured product is not impeded, making it possible to obtain a fiber-reinforced composite material having an excellent weather resistance.

Examples of the glycidylamine type epoxy resin as the component [E] include glycidylamine type epoxy resins having an aromatic ring, and aliphatic glycidylamine type epoxy resins. The glycidylamine type epoxy resin may specifically be, for example, a diaminodiphenylmethane type epoxy resin, a diaminodiphenylsulfone type epoxy resin, an aminophenol type epoxy resin, a m-xylenediamine type epoxy resin or a 1,3-bisaminomethylcyclohexane type epoxy resin.

Examples of commercially available products of the diaminodiphenylmethane type epoxy resin include: ELM434 (manufactured by Sumitomo Chemical Co., Ltd.); “ARALDITE (registered trademark)” MY720, MY721, MY9512 and MY9663 (all of the above manufactured by Huntsman Advanced Materials, Inc.); Epotohto (registered trademark)” YH-434 (manufactured by NIPPON STEEL Chemical & Material Co., Ltd.); and jER (registered trademark)” 604 (manufactured by Mitsubishi Chemical Corporation).

Examples of commercially available products of the diaminodiphenylsulfone type epoxy resin include TG3DAS (manufactured by Mitsui Fine Chemicals, Inc.).

Examples of commercially available products of the aminophenol type epoxy resin include: ELM120 and ELM100 (both manufactured by Sumitomo Chemical Co., Ltd.); “jER (registered trademark)” 630 (manufactured by Mitsubishi Chemical Corporation); and “ARALDITE (registered trademark)” MY0500, MY0510, MY0600 and MY0610 (all of the above manufactured by Huntsman Advanced Materials, Inc.).

Examples of commercially available products of the m-xylenediamine type epoxy resin include “TETRAD (registered trademark)”-X (manufactured by Mitsubishi Gas Chemical Co., Ltd.).

Examples of commercially available products of the 1,3-bisaminomethylcyclohexane type epoxy resin include “TETRAD (registered trademark)”-C (manufactured by Mitsubishi Gas Chemical Co., Ltd.).

The resin composition to be used in the present invention can contain an epoxy resin other than those described above, as appropriate, as long as the effects of the present invention are not impaired. Specific examples thereof include epoxy resins such as bisphenol type epoxy resins, isocyanurate type epoxy resins, dicyclopentadiene type epoxy resins, hydantoin type epoxy resins, trimethylolpropane type epoxy resins, pentaerythritol type epoxy resins, trishydroxyphenylmethane type epoxy resins and tetraphenylolethane type epoxy resins.

Among these resins, examples of commercially available products of the bisphenol A type epoxy resin include: “jER (registered trademark)” 825, 828, 834, 1001, 1002, 1003, 1003F, 1004, 1004AF, 1005F, 1006FS, 1007 and 1009, 1010 (all of the above, manufactured by Mitsubishi Chemical Corporation); “EPICLON (registered trademark)” 850 (manufactured by DIC Corporation); “Epotohto (registered trademark)” YD-128 (manufactured by NIPPON STEEL Chemical & Material Co., Ltd.); and “D. E. R. (registered trademark)”-331 and 332 (both manufactured by The Dow Chemical Company).

Examples of commercially available products of the bisphenol F type epoxy resin include, “ARALDITE (registered trademark)” GY282 (manufactured by Huntsman Advanced Materials, Inc.); “jER (registered trademark)” 806, 807, 4005P, 4007P and 4010P (all of the above, manufactured by Mitsubishi Chemical Corporation); “EPICLON (registered trademark)” 830 (manufactured by DIC Corporation); and “Epotohto (registered trademark)” YD-170 (manufactured by NIPPON STEEL Chemical & Material Co., Ltd.).

The component [D] in the present invention is dicyandiamide. Dicyandiamide is excellent in that it gives high mechanical properties and heat resistance to the cured product of the epoxy resins, and is widely used as a curing agent for various types of epoxy resins. Further, dicyandiamide can be suitably used in the epoxy resin composition, because it imparts excellent weather resistance and preservation stability to the composition. Examples of the commercially available products of dicyandiamide as described above include DICY7 and DICYT5 (both manufactured by Mitsubishi Chemical Corporation).

In the present invention, the content of the component [D] is preferably from 4 to 12 parts by mass with respect to 100 parts by mass of the total epoxy resin, because the resulting resin cured product has an excellent balance between the mechanical properties, the heat resistance and the transparency. The lower limit of the content of the component [D] is more preferably 5 parts by mass or more, and the upper limit thereof is more preferably 10 parts by mass or less.

The resin composition to be used in the prepreg according to the present invention preferably contains a phenoxy resin as a component [G], from the viewpoint of controlling the viscosity of the resin composition and the tackiness of the prepreg. It is preferred that the resin composition contain a phenoxy resin in order to produce a prepreg having an excellent handleability, because the phenoxy resin is capable of improving the viscosity of the resin composition and the tackiness of the prepreg without impairing the weather resistance of the resin cured product.

Examples of commercially available products of the phenoxy resin include “Phenotohto (registered trademark)” YP-50, YP-50S and YP-70 (all of the above manufactured by NIPPON STEEL Chemical & Material Co., Ltd.).

The resin composition to be used in the prepreg according to the present invention may contain a curing accelerator, from the viewpoint of controlling the curing rate. The curing accelerator may be, for example, a urea compound or an imidazole compound, and a urea compound can be preferably used, particularly from the viewpoint of the storage stability of the resin composition.

Examples of the urea compound include 3-(3,4-dichlorophenyl)-1,1-dimethylurea, 3-(4-chlorophenyl)-1,1-dimethylurea, phenyldimethylurea and toluene bisdimethylurea. Further, DCMU99 (manufactured by Hodogaya Chemical Co., Ltd.), “Omicure (registered trademark)” 24 (manufactured by PTI Japan, Ltd.) or the like can be used as a commercially available product of an aromatic urea compound.

The resin composition to be used in the present invention preferably contains, as a component [F], a compound that has a boiling point of 130° C. or higher and a molecular weight m of 50 or more and 250 or less, that does not contain an epoxy group within the molecule, and that does not have an epoxy resin curing ability, because the resulting resin cured product has a higher elastic modulus. In the present invention, compounds such as amines and phenols capable of undergoing addition reactions with epoxy resins, acid anhydrides capable of being copolymerized with epoxy resins, imidazole capable of serving as a self-polymerization reaction initiator of epoxy resins, aromatic urea compounds and tertiary amine compounds, are compounds that have an epoxy resin curing ability, and are not included in the definition of the component [F]. The expression “does not have an epoxy resin curing ability” as used herein refers to the characteristic of not chemically reacting with epoxy resins, and not being involved in the self-polymerization of epoxy resins.

The component [F] is thought to be present in the inter-structure space of a cross-linked structure formed by the reaction of the epoxy resins and dicyandiamide without being taken up into the cross-linked structure, and to maintain that state even after the curing of the epoxy resins. This is thought to cause an increase in the elastic modulus of the resulting resin cured product. Surprisingly, the incorporation of the component [F] described above allows for obtaining a resin cured product which not only has a high elastic modulus, but also has a high elongation and a high strength.

Further, when the component [F] has a boiling point of 130° C. or higher, and more preferably 180° C. or higher, the volatilization of the component [F] during the curing of the resin composition can be reduced, making it possible to obtain a resin cured product or a fiber-reinforced composite material having excellent mechanical properties. It is preferred that the boiling point of the component [F] be adjusted within such a range, because the generation of voids or a decrease in the mechanical properties in the resulting fiber-reinforced composite material can be reduced. Although the upper limit of the boiling point of the component [F] is not particularly limited, many of the compounds usually used in the present invention have a boiling point of 400° C. or lower.

The resin composition preferably contains the component [F] in an amount of from 1 to 15 parts by mass, more preferably from 2 to 10 parts by mass, and still preferably from 3 to 6 parts by mass, with respect to 100 parts by mass of the total epoxy resin.

The component [F] has a molecular weight m of 50 or more and 250 or less, and more preferably 70 or more and 120 or less. When the molecular weight of the component [F] is adjusted within such a range, the component [F] is adequately retained in the inter-structure space of the cross-linked structure formed by the reaction of the epoxy resins and dicyandiamide, making it possible to obtain a cured product having an excellent elastic modulus, strength and elongation.

In the present invention, the component [F] is preferably a compound having at least one functional group selected from the group consisting of an amide group, a ketone group and a hydroxyl group, within the molecule. When the component [F] has a high-polarity functional group such as one described above within the molecule, a strong intermolecular interaction acts between the hydroxyl group in the cross-linked structure formed from the epoxy resins and dicyandiamide, and the component [F]. This facilitates the component [F] to be more adequately retained in the inter-structure space of the cross-linked structure, making it possible to obtain a particularly excellent effect of improving the elongation and the strength. Further, when the component [F] has a high-polarity functional group such as one described above, it is possible to accelerate the dissolution of dicyandiamide as the component [D], and to improve the transparency of the resin cured product.

Examples of the component [F] as described above include: amides such as N-methylformamide, N-methylacetamide, 2-pyrrolidone, N-methylpropionamide, N-ethylacetamide, N-methylacetanilide and N,N′-diphenylacetamide; and diols such as ethanediol, propanediol, butanediol, pentanediol, hexandiol and heptanediol. These compounds may be used singly, or may be used in an appropriate mixture.

Preferred examples of the reinforcing fibers to be used in the prepreg and the fiber-reinforced composite material according to the present invention include carbon fibers, graphite fibers, aramid fibers and glass fibers. Among these, carbon fibers are particularly preferred. The form and the arrangement of the reinforcing fibers are not limited. For example, a fiber structure such as unidirectionally aligned continuous fibers, a single tow, a woven fabric, a knitted fabric, a braid or the like is used. As the reinforcing fibers, it is also possible to use a combination of two or more types of carbon fibers, glass fibers, aramid fibers, boron fibers, PBO fibers, high-strength polyethylene fibers, alumina fibers, silicon carbide fibers and the like.

Specific examples of the carbon fibers include acrylic carbon fibers, pitch-based carbon fibers and rayon-based carbon fibers. In particular, acrylic carbon fibers having a high tensile strength are preferably used.

The carbon fibers can be used in the form of twisted yams, untwisted yams, non-twisted yams or the like. However, the use of twisted yams causes a decrease in the mechanical properties of the resulting carbon fiber-reinforced composite material, since the orientations of the filaments constituting the carbon fibers in twisted yams are not parallel to one another. Therefore, untwisted yams or non-twisted yams which allow for achieving a good balance between the moldability and the strength properties in the carbon fiber-reinforced composite material, are preferably used.

The carbon fibers preferably have a tensile elastic modulus within the range of from 200 to 440 GPa. The tensile elastic modulus of the carbon fibers is affected by the degree of crystallization of the graphite structure of the carbon fibers, and the higher the degree of crystallization is, the more improved the elastic modulus is. The carbon fibers preferably have a tensile elastic modulus within the range described above, because all of the rigidity and strength properties of the resulting carbon fiber-reinforced composite material are balanced at a high level. The carbon fibers more preferably have a tensile elastic modulus within the range of from 230 to 400 GPa, and still more preferably within the range of from 260 to 370 GPa. The tensile elastic modulus of the carbon fibers as used herein is a value measured in accordance with JIS R7601 (2006).

The prepreg according to the present invention can be produced by any of various known methods. For example, the prepreg can be produced by the hot melt method in which the viscosity of the resin composition is reduced by heating, without using an organic solvent, and then the reinforcing fibers are impregnated with the resin composition.

The hot melt method can be carried out, for example, by a process in which the reinforcing fibers are directly impregnated with the resin composition whose viscosity is reduced by heating, or by a process in which the resin composition is coated on a release paper or the like to prepare a release paper sheet with a resin film, first, and then the resin film is layered on one side or each of both sides of the reinforcing fibers, followed by heating and pressurization, thereby impregnating the reinforcing fibers with the resin composition.

The content of the reinforcing fibers in the prepreg is preferably from 30 to 90% by mass, more preferably from 35 to 85% by mass, and still more preferably from 65 to 85% by mass. A low fiber mass content leads to an excessive amount of the resin, making the advantage of the fiber-reinforced composite material to have an excellent specific strength and specific modulus less likely to be obtained. In addition, there are cases where the amount of heat generated during curing may be excessively high, at the time of molding the fiber-reinforced composite material. On the other hand, too high a fiber mass content may lead to a defective impregnation of the resin, and there is a risk that the resulting composite material has a number of voids. In addition, there is a risk that the tacking property of the prepreg may be impaired.

The fiber-reinforced composite material or the tubular fiber-reinforced composite material according to the present invention can be produced, for example, by a method in which the above-described prepregs according to the present invention are laminated in a predetermined form, followed by pressurization and heating to cure the resin. At this time, the application of heat and pressure can be carried out using a method such as press molding, autoclave molding, bagging molding, wrapping tape molding, internal pressure molding or the like.

The wrapping tape molding is particularly preferably used as the method of molding the tubular fiber-reinforced composite material. The wrapping tape molding is a method in which a prepreg is wound around a core such as a mandrel, to obtain a cylindrical molded product. Specifically, the wrapping tape molding is a method in which a prepreg is wound around a mandrel, a wrapping tape composed of a thermoplastic resin film is wrapped around the outer periphery of the wound prepreg in order to fix the prepreg and to apply a pressure thereto, and the resin is heat-cured in an oven, followed by pulling out the core, to obtain a cylindrical molded product. The wrapping tape molding is suitable when producing a tubular body such as a golf club shaft or a fishing rod.

When the resin composition according to the present invention is used, the cured product thereof has excellent mechanical properties, weather resistance and degree of transparency, and therefore, the tubular fiber-reinforced composite material according to the present invention exhibits an excellent flexural strength, weather resistance and appearance.

The fiber-reinforced composite material or the tubular fiber-reinforced composite material according to the present invention can be widely used in aerospace applications, general industrial applications and sports applications. More specifically, in general industrial applications, the fiber-reinforced composite material or the tubular fiber-reinforced composite material is suitably used in structures such as automobiles, marine vessels and railroad vehicles. In sports application, the fiber-reinforced composite material or the tubular fiber-reinforced composite material is suitably used in the applications of golf club shafts, fishing rods, tennis rackets and badminton rackets. In particular, the tubular fiber-reinforced composite material according to the present invention can be suitably used for a golf club shaft or a fishing rod.

The upper limits and lower limits of the numerical ranges described above can be arbitrarily combined, unless otherwise specified.

### EXAMPLES

The present invention will now be described in further detail with reference to Examples. However, the scope of the present invention is in no way limited to these Examples. The unit “part(s)“used to describe the composition ratio refers to” part(s) by mass” unless otherwise specified. The measurements of various properties (physical properties) were carried out in an environment of a temperature of 23° C. and a relative humidity of 50%, unless otherwise specified. Further, the unit of the amount of each component shown in Tables are all “part(s) by mass”.

### <Materials Used in Examples and Comparative Examples>

### (1) Reinforcing Fibers

“TORAYCA (registered trademark)” T1100 G-24K (number of fibers: 24,000, tensile elastic modulus: 324 GPa, density: 1.8 g/cm³, manufactured by Toray Industries, Inc.)

### (2) Epoxy Resins

### Component [A]: Novolac Type Epoxy Resin

[A]-1 “EPICLON (registered trademark)” N-775 (phenol novolac type epoxy resin, epoxy equivalent: 189, manufactured by DIC Corporation)
[A]-2 “EPICLON (registered trademark)” N-695 (cresol novolac type epoxy resin, epoxy equivalent: 214, manufactured by DIC Corporation)

### Component [B]: Oxazolidone Type Epoxy Resin

[B]-1 “D. E. R. (registered trademark)” 858 (epoxy equivalent: 400, manufactured by The Dow Chemical Company)

### Component [C]: Sorbitol Type Epoxy Resin, Glycerol Type Epoxy Resin

[C]-1 “DENACOL (registered trademark)” EX-614B (sorbitol type epoxy resin, epoxy equivalent: 173, manufactured by Nagase ChemteX Corporation)
[C]-2 “DENACOL (registered trademark)” EX-512 (polyglycerol type epoxy resin, epoxy equivalent: 168, manufactured by Nagase ChemteX Corporation)

### Component [E]: Glycidylamine Type Epoxy Resin

[E]-1 “ARALDITE (registered trademark)” MY0600 (aminophenol type epoxy resin, epoxy equivalent: 118, manufactured by Huntsman Advanced Materials, Inc.)

### Component [H]: Other Epoxy Resin

[H]-1 “EPICLON (registered trademark)” 830 (bisphenol F type epoxy resin, epoxy equivalent: 172, manufactured by DIC Corporation)
[H]-2 “DENACOL (registered trademark)” EX-411 (pentaerythritol type epoxy resin, epoxy equivalent: 229, manufactured by Nagase ChemteX Corporation)

### (3) Component [D]: Dicyandiamide

[D]-1 DICY7 (dicyandiamide, manufactured by Mitsubishi Chemical Corporation)

### (4) Component [F]:

Compound that has a boiling point of 130° C. or higher and a molecular weight m of 50 or more and 250 or less, that does not contain an epoxy group within the molecule, and that does not have an epoxy resin curing ability.
[F]-1 2-Pyrrolidone (boiling point: 245° C., molecular weight m: 85, manufactured by Tokyo Chemical Industry Co., Ltd.)
[F]-2 1,2-Propanediol (boiling point: 188° C., molecular weight m: 76, manufactured by Tokyo Chemical Industry Co., Ltd.)

### (5) Component [G]: Phenoxy Resin

[G]-1 “Phenotohto (registered trademark)” YP-70 (manufactured by NIPPON STEEL Chemical & Material Co., Ltd.)

### (6) Curing Accelerator

DCMU99 (3-(3,4-dichlorophenyl)-1,1-dimethylurea, manufactured by Hodogaya Chemical Co., Ltd.).

### <Method of Preparing Resin Composition>

### (1) Preparation of Curing Agent Master Batch

In each of the Examples and Comparative Examples, any of the epoxy resins which are in a liquid state at normal temperature ([C]-1, [C]-2, [H]-1, and [H]-2 fall under this category) was/were prepared in an amount of 10 parts by mass (10 parts by mass with respect to 100 parts by mass of the all the epoxy resins). To the resultant, dicyandiamide as the component [D] was added, respectively, and kneaded at room temperature. The resulting mixture was passed through a three-roll mill twice, to prepare a curing agent master batch.

### (2) Preparation of Resin Composition

A quantity of 90 parts by mass of all of the epoxy resins excluding 10 parts by mass of the epoxy resin(s) in a liquid state used in the section (1) above, were introduced into a beaker. After heating the epoxy resins to 150° C. while kneading, a phenoxy resin as the component [G] was introduced into the beaker, and heat-kneaded at a temperature of 150° C. for 1 hour, to dissolve the resins. Subsequently the mixture was cooled to a temperature of from 55 to 65° C. while continuing kneading. Thereafter, the curing agent master batch prepared in the section (1) above, and the components as the component [F] and the curing accelerator in the amounts shown in each Table, were introduced, and the resulting mixture was kneaded at the same temperature for 30 minutes, to obtain a resin composition. The compositions of the respective Examples and Comparative Examples are shown in Tables 1 to 5.

### <Method of Preparing Resin Cured Product>

Each resin composition prepared in accordance with the section of <Method of Preparing Resin Composition> described above was degassed in vacuum. Thereafter, the resin composition was heated from 30° C. at a rate of 1.7° C./min, in a mold which had been set so as to achieve a thickness of 2 mm with a 2 mm-thick “TEFLON (registered trademark)” spacer, and the temperature was retained for one hour after having reached 90° C. Subsequently, the resin composition was heated at a rate of 2.0° C./min, and cured for 2 hours after having reached a temperature of 135° C., to obtain a resin cured product in the form of a plate having a thickness of 2 mm.

For the evaluation of appearance, the curing reaction as described above was carried out in a mold which had been set so as to achieve a thickness of 1 mm with a 1 mm-thick “TEFLON (registered trademark)” spacer, to obtain a resin cured product in the form of a plate having a thickness of 1 mm.

### <Method of Preparing Prepreg>

Each resin composition prepared in accordance with the section of <Method of Preparing Resin Composition> described above was coated on release papers using a knife coater, to prepare two pieces of resin films having a resin basis weight of 31 g/m². Subsequently, reinforcing fibers (“TORAYCA (registered trademark)” T1100 G-24K described above) were unidirectionally aligned so as to be in the form of a sheet having a fiber basis weight of 125 g/m², and the above-prepared resin films were respectively layered on both surfaces of the reinforcing fibers, followed by heating and pressurization under the conditions of a temperature of 110° C. and a maximum pressure of 2 MPa to impregnate the reinforcing fibers with the resin composition, thereby obtaining a prepreg.

### <Various Evaluation Methods>

### (1) Three-Point Bending Measurement of Resin Cured Product

Test pieces each having a width of 10 mm and a length of 60 mm were cut out from each resin cured product having a thickness of 2 mm, which had been prepared in accordance with the section of <Method of Preparing Resin Cured Product> describe above. Using an Instron universal tester (manufactured by Instron Corporation), the three-point bending measurements of the test pieces were carried out with a span of 32 mm, a cross-head speed of 2.5 mm/min and a number of samples of n=6, in accordance with JIS K7171 (1994). The arithmetic mean value of the measured elastic modulus values was defined as the flexural elastic modulus of the resin cured product.

### (2) Measurement of Glass Transition Temperature of Resin Cured Product

A test piece having a width of 12.7 mm and a length of 55 mm was cut out from each resin cured product having a thickness of 2 mm, which had been prepared in accordance with the section of <Method of Preparing Resin Cured Product> describe above. Using a viscoelasticity measuring apparatus (ARES, manufactured by TA Instruments, Inc.), the DMA measurement of the thus prepared test piece was carried out under the conditions of a torsional vibration frequency of 1.0 Hz and a heating rate of 5.0° C./min, within the temperature range of from 40 to 250° C., and the glass transition temperature of the test piece was read. The glass transition temperature was defined as the temperature at the intersection of the tangent line in the glass state and the tangent line in the transition state, in the storage elastic modulus G′ curve.

### (3) Evaluation of Degree of Transparency of Resin Cured Product

Each resin cured product having a thickness of 1 mm, which had been prepared in accordance with the section of <Method of Preparing Resin Cured Product> describe above, was placed on a paper on which letters had been written, and a measurer having a visual acuity of about 1.0 as measured using a Landolt ring, examined the degree of transparency of the resin cured product. The degree of transparency was evaluated as A when the letters were readable as clearly as before placing the resin cured product on the paper; evaluated as B when the letters were vague but readable; and evaluated as C when the letters were not readable.

### (4) Weather Resistance Test of Resin Cured Product

A test piece having a width of 37 mm and a length of 68 mm was cut out from each resin cured product having a thickness of 1 mm, which had been prepared in accordance with the section of <Method of Preparing Resin Cured Product> describe above. Using an accelerated weather resistance tester (Super Xenon Weather Meter SX-75, manufactured by Suga Test Instruments Co., Ltd.), the thus prepared test piece was subjected to a weather resistance test. In the weather resistance test, an irradiation without water injection for 102 minutes which is performed under the conditions of an intensity of 180 W/m², a black panel temperature of 63° C. and a humidity of 50% RH, and an irradiation with water injection for 18 minutes which is performed under the conditions of an intensity of 180 W/m², an in-tank temperature of 28° C. and a humidity of 99% RH, were taken as one cycle, and this cycle was repeated 12 times (namely, for 24 hours).

The weather resistance was evaluated by measuring the color difference (ΔE) of the cured product before and after the weather resistance test, using a multi-light source spectrophotometer MSC-P (manufactured by Suga Test Instruments Co., Ltd.). The tristimulus values (L*, a* and b*) of the test piece were determined by the reflection method with a D65 light source and a visual field of 10°, under the optical condition of d/8 excluding the specular reflection light, and the color difference (ΔE) was calculated using the differences (ΔL*, Δa* and Δb*) in the tristimulus values before and after the weather resistance test, in accordance with the following equation (I).

$$Δ E = {\{ {( Δ {L}^{*} )}^{2} + {( Δ {a}^{*} )}^{2} + {( Δ {b}^{*} )}^{2} \}}^{1 / 2} \qquad ( I )$$

### (5) Weather Resistance Test of Fiber-Reinforced Composite Material

Twenty plies of each prepreg prepared in accordance with the section of <Method of Preparing Prepreg> described above were laminated, with the fiber directions thereof aligned. The resulting laminate was heated in an autoclave from 30° C. to 90° C. at a rate of 1.7° C./min under a pressure of 0.7 MPa, maintained at a temperature of 90° C. for 60 minutes, then heated to 135° C. at a rate of 2.0° C./min, and molded at a temperature of 135° C. for 120 minutes, to prepare a unidirectional CFRP plate having a thickness of 2 mm. Thereafter, test pieces having a width of 37 mm and a length of 68 mm were cut out from the CFRP plate. One of the thus cut out test pieces was placed in an outdoor location with no roof at which there is no shade while the sun is out, and left to stand for 2 months, to perform the weather resistance test. The test pieces before and after the weather resistance test were arranged side by side, and 10 subjects were asked if they noticed any difference in the color between the test pieces. The weather resistance was evaluated as “Good” when 8 or more subjects out of 10 subjects answered “there is no change in the color”, or “no difference in the color is noticeable”; and evaluated as “Poor” when 3 or more subjects answered “there is a change in the color”.

### Example 1

A resin composition was prepared in accordance with the section of <Method of Preparing Resin Composition> described above, using the following components: 35 parts by mass of “EPICLON (registered trademark)” N-775 as the component [A], 25 parts by mass of “D. E. R. (registered trademark)” 858 as the component [B], 20 parts by mass of “DENACOL (registered trademark)” EX-614B as the component [C], and 20 parts by mass of “EPICLON (registered trademark)” 830 as the other epoxy resin (component [H]), all of which are epoxy resins; 5.8 parts by mass of DICY7 which is dicyandiamide, as the component [D]; 3 parts by mass of “Phenotohto (registered trademark)” YP-70 which is a phenoxy resin, as the component [G]; and 3 parts by mass of DCMU99 as the curing accelerator.

A resin cured product was prepared from the resulting resin composition, in accordance with the section of <Method of Preparing Resin Cured Product>. The flexural elastic modulus, the glass transition temperature, the degree of transparency and the weather resistance (color difference ΔE), of the thus prepared resin cured product, were measured. As a result, the resin cured product had a flexural elastic modulus of 4.0 GPa, a glass transition temperature of 140° C., a degree of transparency of “A” and a color difference ΔE of 6.7, indicating that the resin cured product has good physical properties and appearance.

Further, a prepreg was prepared from the resulting resin composition in accordance with the section of <Method of Preparing Prepreg>, and the weather resistance of the resulting fiber-reinforced composite material was measured in accordance with the section of (5) Weather Resistance test of Fiber-Reinforced Composite Material, under <Various Evaluation Methods>. As a result, the fiber-reinforced composite material had a good weather resistance.

### Examples 2 to 14

In each of the Examples, a resin cured product and a prepreg were prepared in the same manner as in Example 1, except that the composition was changed as shown in Table 1. The flexural elastic modulus, the glass transition temperature, the degree of transparency and the weather resistance (color difference ΔE) of the resin cured product, as well as the weather resistance of the fiber-reinforced composite material, in each Example, were as shown in Table 1, which were all good.

### Comparative Example 1

A resin cured product and a prepreg were prepared in the same manner as in Example 1, except that the composition shown in Table 2 was used. The evaluation results of physical properties are also shown in Table 1 (the same applies to the Comparative Examples to be described hereinafter). The resin cured product had a good degree of transparency and weather resistance, and the fiber-reinforced composite material had a good weather resistance. However, the flexural elastic modulus and the glass transition temperature of the resin cured product were lower than those in Example 5, because the content of the component [A] in 100 parts by mass of the total epoxy resin was less than 20 parts by mass, failing to satisfy the requirement (1).

### Comparative Example 2

A resin cured product and a prepreg were prepared in the same manner as in Example 1, except that the composition shown in Table 3 was used. The resin cured product had a good flexural elastic modulus, glass transition temperature and weather resistance, and the fiber-reinforced composite material had a good weather resistance. However, the degree of transparency of the resin cured product was inferior to that in Example 6, because the content of the component [A] in 100 parts by mass of the total epoxy resin was more than 50 parts by mass, failing to satisfy the requirement (1).

### Comparative Example 3

A resin cured product and a prepreg were prepared in the same manner as in Example 1, except that the composition shown in Table 4 was used. The resin cured product had a good flexural elastic modulus, degree of transparency and weather resistance, and the fiber-reinforced composite material had a good weather resistance. However, the glass transition temperature was lower than that in Example 8, because the content of the component [B] in 100 parts by mass of the total epoxy resin was less than 10 parts by mass, failing to satisfy the requirement (2).

### Comparative Example 4

A resin cured product and a prepreg were prepared in the same manner as in Example 1, except that the composition shown in Table 2 was used. The resin cured product had a good glass transition temperature, degree of transparency and weather resistance, and the fiber-reinforced composite material had a good weather resistance. However, the flexural elastic modulus of the resin cured product was lower than that in Example 5, because the content of the component [B] in 100 parts by mass of the total epoxy resin was more than 40 parts by mass, failing to satisfy the requirement (2).

### Comparative Example 5

A resin cured product and a prepreg were prepared in the same manner as in Example 1, except that the composition shown in Table 2 was used. The resin cured product had a good glass transition temperature, degree of transparency and weather resistance, and the fiber-reinforced composite material had a good weather resistance. However, the flexural elastic modulus was lower than that in Example 5, because the content of the component [C] in 100 parts by mass of the total epoxy resin was less than 10 parts by mass, failing to satisfy the requirement (3).

### Comparative Example 6

A resin cured product and a prepreg were prepared in the same manner as in Example 1, except that the composition shown in Table 4 was used. The resin cured product had a good flexural elastic modulus, degree of transparency and weather resistance, and the fiber-reinforced composite material had a good weather resistance. However, the glass transition temperature of the resin cured product was lower than that in Example 8, because the content of the component [C] in 100 parts by mass of the total epoxy resin was more than 40 parts by mass, failing to satisfy the requirement (3).

### Comparative Example 7

A resin cured product and a prepreg were prepared in the same manner as in Example 1, except that the composition shown in Table 3 was used. The resin cured product had a good flexural elastic modulus, glass transition temperature and weather resistance, and the fiber-reinforced composite material had a good weather resistance. However, the degree of transparency of the resin cured product was inferior to that in Example 6, because the total content of the component [B] and the component [C] in 100 parts by mass of the total epoxy resin was less than 40 parts by mass, failing to satisfy the requirement (4).

### Comparative Example 8

A resin cured product and a prepreg were prepared in the same manner as in Example 1, except that the composition shown in Table 4 was used. The resin cured product had a good flexural elastic modulus, degree of transparency and weather resistance, and the fiber-reinforced composite material had a good weather resistance. However, the glass transition temperature of the resin cured product was lower than that in Example 9, because the content of the component [C] in 100 parts by mass of the total epoxy resin was more than 40 parts by mass, failing to satisfy the requirement (3), and also because the content of the component [A] in 100 parts by mass of the total epoxy resin was less than 20 parts by mass, failing to satisfy the requirement (1), as well.

### Comparative Example 9 and Comparative Example 10

In each Comparative Example, a resin cured product and a prepreg were prepared in the same manner as in Example 1, except that the composition shown in Table 5 was used. Each resin cured product had a good glass transition temperature, degree of transparency and weather resistance, and each fiber-reinforced composite material had a good weather resistance. However, the flexural elastic modulus was lower than that in all the Examples, because the component [C] was not incorporated, failing to satisfy the requirement (3).

### Comparative Example 11

A resin cured product and a prepreg were prepared in the same manner as in Example 1, except that the composition shown in Table 5 was used. The resin cured product had a good flexural elastic modulus, glass transition temperature and weather resistance, and the fiber-reinforced composite material had a good weather resistance. However, the degree of transparency was inferior to that in all the Examples, because the component [C] was not incorporated, failing to satisfy the requirement (3).

### Comparative Example 12

A resin cured product and a prepreg were prepared in the same manner as in Example 1, except that the composition shown in Table 3 was used. The resin cured product had a good flexural elastic modulus, glass transition temperature and weather resistance, and the fiber-reinforced composite material had a good weather resistance. However, the degree of transparency was inferior to that in Example 6. This is because the resin composition does not contain the component [C], and contains a pentaerythritol type epoxy resin (an aliphatic epoxy resin having no hydroxyl group), instead, thereby failing to satisfy the requirement (3).

### Comparative Example 13

A resin cured product and a prepreg were prepared in the same manner as in Example 1, except that the composition shown in Table 3 was used. The resin cured product had a good flexural elastic modulus, glass transition temperature and degree of transparency. However, the weather resistance of the resin cured product and the weather resistance of the fiber-reinforced composite material were inferior to those in Example 6 and Example 10, because the content of the component [E] in 100 parts by mass of the total epoxy resin was more than 10 parts by mass, failing to satisfy the requirement (5).

### Comparative Example 14

A resin cured product and a prepreg were prepared in the same manner as in Example 1, except that the composition shown in Table 2 was used. The resin cured product had a good glass transition temperature, degree of transparency and weather resistance, and the fiber-reinforced composite material had a good weather resistance. However, the flexural elastic modulus of the resin cured product was lower than that in Example 5, because the component [D] was not incorporated.

### Comparative Example 15

A resin cured product and a prepreg were prepared in the same manner as in Example 1, except that the composition shown in Table 3 was used. The resin cured product had a good flexural elastic modulus, glass transition temperature and weather resistance, and the fiber-reinforced composite material had a good weather resistance. However, the degree of transparency of the resin cured product was inferior to that in Example 6, because the total content of the component [B] and the component [C] in 100 parts by mass of the total epoxy resin was less than 40 parts by mass, failing to satisfy the requirement (4).

TABLE 1

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Component [A] | “EPICLON” N-775 | 35 | | | | | 45 | 35 | 35 |
| | “EPICLON” N-695 | | 35 | 35 | 35 | 25 | | | |
| Component [B] | “D.E.R.” 858 | 25 | 25 | 25 | 35 | 35 | 25 | 25 | 15 |
| Component [C] | “DENACOL” EX- | 20 | | 15 | 15 | 15 | 20 | 35 | 35 |
| | 614B | | | | | | | | |
| | “DENACOL” EX- | | 20 | | | | | | |
| | 512 | | | | | | | | |
| Component [E] | “ARALDITE” | | | | | | | | |
| | MY0600 | | | | | | | | |
| Component [H] | “EPICLON” 830 | 20 | 20 | 25 | 15 | 25 | 10 | 5 | 15 |
| | “DENACOL” EX- | | | | | | | | |
| | 411 | | | | | | | | |
| Component [D] | DICY7 | 5.8 | 5.5 | 5.5 | 5.1 | 5.2 | 5.7 | 5.8 | 6.1 |
| Component [F] | 2-Pyrrolidone | | | | | | | | |
| | 1,2-Propanediol | | | | | | | | |
| Component [G] | “Phenotohto” YP-70 | 3 | 3 | 3 | 3 | 3 | 3 | 3 | 3 |
| Curing accelerator | DCMU99 | 3 | 3 | 3 | 3 | 3 | 3 | 3 | 3 |
| Properties of resin | Flexural elastic | 4.0 | 3.9 | 4.0 | 3.9 | 3.8 | 4.0 | 4.2 | 4.2 |
| cured product | modulus [GPa] | | | | | | | | |
| | Glass transition | 140 | 138 | 141 | 143 | 134 | 142 | 135 | 130 |
| | temperature [° C.] | | | | | | | | |
| | Degree of | A | A | A | A | A | B | A | A |
| | transparency | | | | | | | | |
| | Weather resistance | 6.7 | 7.2 | 7.3 | 7.0 | 6.8 | 8.2 | 6.5 | 6.5 |
| | (ΔE) | | | | | | | | |
| Properties of | Weather resistance | Good | Good | Good | Good | Good | Good | Good | Good |
| composite | | | | | | | | | |

| | | Exam- | Exam- | Exam- | Exam- | Exam- | Exam- |
|---|---|---|---|---|---|---|---|
| | | ple 9 | ple 10 | ple 11 | ple 12 | ple 13 | ple 14 |
| Component [A] | “EPICLON” N-775 | | 45 | 35 | | 35 | |
| | “EPICLON” N-695 | 25 | | | 25 | | 35 |
| Component [B] | “D.E.R.” 858 | 40 | 25 | 25 | 35 | 25 | 25 |
| Component [C] | “DENACOL” EX- | 35 | 20 | 20 | 15 | 20 | |
| | 614B | | | | | | |
| | “DENACOL” EX- | | | | | | 20 |
| | 512 | | | | | | |
| Component [E] | “ARALDITE” | | 5 | | | | |
| | MY0600 | | | | | | |
| Component [H] | “EPICLON” 830 | | 5 | 20 | 25 | 20 | 20 |
| | “DENACOL” EX- | | | | | | |
| | 411 | | | | | | |
| Component [D] | DICY7 | 5.0 | 5.9 | 5.8 | 6.8 | 5.8 | 5.5 |
| Component [F] | 2-Pyrrolidone | | | | | 3 | |
| | 1,2-Propanediol | | | | | | 3 |
| Component [G] | “Phenotohto” YP-70 | 3 | 3 | | 3 | 3 | 3 |
| Curing accelerator | DCMU99 | 3 | 3 | 3 | 3 | 3 | 3 |
| Properties of resin | Flexural elastic | 4.0 | 4.1 | 4.0 | 4.0 | 4.2 | 4.1 |
| cured product | modulus [GPa] | | | | | | |
| | Glass transition | 131 | 146 | 141 | 138 | 131 | 130 |
| | temperature [° C.] | | | | | | |
| | Degree of | A | B | B | A | A | A |
| | transparency | | | | | | |
| | Weather resistance | 6.2 | 9.3 | 7.5 | 7.0 | 6.5 | 6.9 |
| | (ΔE) | | | | | | |
| Properties of | Weather resistance | Good | Good | Good | Good | Good | Good |
| composite | | | | | | | |

TABLE 2

| | | Example | Example | Example | Comparative | Comparative | Comparative | Comparative |
|---|---|---|---|---|---|---|---|---|
| | | 1 | 5 | 12 | Example 1 | Example 4 | Example 5 | Example 14 |
| Component [A] | “EPICLON”N-775 | 35 | | | | | | |
| | “EPICLON”N-695 | | 25 | 25 | 15 | 25 | 25 | 25 |
| Component [B] | “D.E.R.”858 | 25 | 35 | 35 | 35 | 45 | 35 | 35 |
| Component [C] | “DENACOL” EX-614B | 20 | 15 | 15 | 15 | 15 | 5 | 15 |
| | “DENACOL” EX-512 | | | | | | | |
| Component [E] | “ARALDITE” MY0600 | | | | | | | |
| Component [H] | “EPICLON”830 | 20 | 25 | 25 | 35 | 15 | 35 | 25 |
| | “DENACOL” EX-411 | | | | | | | |
| Component [D] | DICY7 | 5.8 | 5.2 | 6.8 | 5.4 | 4.8 | 5.2 | |
| Component [F] | 2-Pyrrolidone | | | | | | | |
| | 1,2-Propanediol | | | | | | | |
| Component [G] | “Phenotohto” YP-70 | 3 | 3 | 3 | 3 | 3 | 3 | 3 |
| Curing accelerator | DCMU99 | 3 | 3 | 3 | 3 | 3 | 3 | 3 |
| Properties of resin | Flexural elastic modulus [GPa] | 4.0 | 3.8 | 4.0 | 3.6 | 3.6 | 3.6 | 3.3 |
| cured product | Glass transition temperature [° C.] | 140 | 134 | 138 | 125 | 139 | 137 | 132 |
| | Degree of transparency | A | A | A | A | A | B | A |
| | Weather resistance (ΔE) | 6.7 | 6.8 | 7.0 | 6.4 | 7.3 | 8.3 | 6.6 |
| Properties of | Weather resistance | Good | Good | Good | Good | Good | Good | Good |
| composite | | | | | | | | |

TABLE 3

| | | Exam- | Exam- | Exam- | Comparative | Comparative | Comparative | Comparative | Comparative |
|---|---|---|---|---|---|---|---|---|---|
| | | ple 1 | ple 6 | ple 10 | Example 2 | Example 7 | Example 12 | Example 13 | Example 15 |
| Component [A] | “EPICLON”N-775 | 35 | 45 | 45 | 55 | 45 | 45 | 45 | 45 |
| | “EPICLON”N-695 | | | | | | | | |
| Component [B] | “D.E.R.”858 | 25 | 25 | 25 | 25 | 25 | 25 | 25 | 15 |
| Component [C] | “DENACOL” EX-614B | 20 | 20 | 20 | 20 | 10 | | 15 | 20 |
| | “DENACOL” EX-512 | | | | | | | | |
| Component [E] | “ARALDITE” MY0600 | | | 5 | | | | 15 | |
| Component [H] | “EPICLON”830 | 20 | 10 | 5 | | 20 | 10 | | 20 |
| | “DENACOL” EX-411 | | | | | | 20 | | |
| Component [D] | DICY7 | 5.8 | 5.7 | 5.9 | 5.6 | 5.7 | 5.0 | 6.3 | 6.1 |
| Component [F] | 2-Pyrrolidone | | | | | | | | |
| | 1,2-Propanediol | | | | | | | | |
| Component [G] | “Phenotohto” YP-70 | 3 | 3 | 3 | 3 | 3 | 3 | 3 | 3 |
| Curing | DCMU99 | 3 | 3 | 3 | 3 | 3 | 3 | 3 | 3 |
| accelerator | | | | | | | | | |
| Properties of | Flexural elastic modulus [GPa] | 4.0 | 4.0 | 4.1 | 4.1 | 3.7 | 4.0 | 4.2 | 4.1 |
| resin cured | Glass transition temperature | 140 | 142 | 146 | 147 | 144 | 136 | 157 | 134 |
| product | [° C.] | | | | | | | | |
| | Degree of transparency | A | B | B | C | C | C | B | C |
| | Weather resistance (ΔE) | 6.7 | 8.2 | 9.3 | 9.1 | 9.1 | 8.5 | 11.3 | 9.3 |
| Properties of | Weather resistance | Good | Good | Good | Good | Good | Good | Poor | Good |
| composite | | | | | | | | | |

TABLE 4

| | | Example | Example | Example | Comparative | Comparative | Comparative |
|---|---|---|---|---|---|---|---|
| | | 1 | 8 | 9 | Example 3 | Example 6 | Example 8 |
| Component [A] | “EPICLON”N-775 | 35 | 35 | | 35 | 35 | |
| | “EPICLON”N-695 | | | 25 | | | 15 |
| Component [B] | “D.E.R.”858 | 25 | 15 | 40 | 5 | 15 | 40 |
| Component [C] | “DENACOL” EX-614B | 20 | 35 | 35 | 35 | 45 | 45 |
| | “DENACOL” EX-512 | | | | | | |
| Component [E] | “ARALDITE” MY0600 | | | | | | |
| Component [H] | “EPICLON”830 | 20 | 15 | | 25 | 5 | |
| | “DENACOL” EX-411 | | | | | | |
| Component [D] | DICY7 | 5.8 | 6.1 | 5.0 | 6.5 | 6.1 | 5.3 |
| Component [F] | 2-Pyrrolidone | | | | | | |
| | 1,2-Propanediol | | | | | | |
| Component [G] | “Phenotohto” YP-70 | 3 | 3 | 3 | 3 | 3 | 3 |
| Curing | DCMU99 | 3 | 3 | 3 | 3 | 3 | 3 |
| accelerator | | | | | | | |
| Properties of | Flexural elastic modulus [GPa] | 4.0 | 4.2 | 4.0 | 4.3 | 4.3 | 4.0 |
| resin cured | Glass transition temperature [° C.] | 140 | 130 | 131 | 123 | 124 | 119 |
| product | Degree of transparency | A | A | A | B | A | A |
| | Weather resistance (ΔE) | 6.7 | 6.5 | 6.2 | 8.0 | 6.6 | 6.4 |
| Properties of | Weather resistance | Good | Good | Good | Good | Good | Good |
| composite | | | | | | | |

TABLE 5

| | | | Comparative | Comparative | Comparative |
|---|---|---|---|---|---|
| | | Example 1 | Example 9 | Example 10 | Example 11 |
| Component [A] | “EPICLON”N-775 | 35 | 30 | 20 | 20 |
| | “EPICLON”N-695 | | | | |
| Component [B] | “D.E.R.”858 | 25 | 35 | 20 | 50 |
| Component [C] | “DENACOL” EX-614B | 20 | | | |
| | “DENACOL” EX-512 | | | | |
| Component [E] | “ARALDITE” MY0600 | | | | |
| Component [H] | “EPICLON”830 | 20 | 35 | 60 | 30 |
| | “DENACOL” EX-411 | | | | |
| Component [D] | DICY7 | 5.8 | 5.4 | 2.0 | 6.5 |
| Component [F] | 2-Pyrrolidone | | | | |
| | 1,2-Propanediol | | | | |
| Component [G] | “Phenotohto” YP-70 | 3 | 3 | 3 | 3 |
| Curing | DCMU99 | 3 | 3 | 3 | 3 |
| accelerator | | | | | |
| Properties of | Flexural elastic modulus | 4.0 | 3.6 | 3.3 | 3.7 |
| resin cured | [GPa] | | | | |
| product | Glass transition | 140 | 145 | 130 | 147 |
| | temperature [° C.] | | | | |
| | Degree of transparency | A | B | A | C |
| | Weather resistance (ΔE) | 6.7 | 8.6 | 6.8 | 8.4 |
| Properties of | Weather resistance | Good | Good | Good | Good |
| composite | | | | | |

1. A prepreg comprising reinforcing fibers and a resin composition,
wherein said resin composition contains the following component [A] to component [D]:
component [A]: a novolac type epoxy resin;
component [B]: an oxazolidone type epoxy resin;
component [C]: one or both of a sorbitol type epoxy resin and a glycerol type epoxy resin; and
component [D]: dicyandiamide; and
wherein said resin composition satisfies the following requirement (1) to requirement (5):
requirement (1): the content of said component [A] is from 20 to 50 parts by mass, with respect to 100 parts by mass of the total epoxy resin;
requirement (2): the content of said component [B] is from 10 to 40 parts by mass, with respect to 100 parts by mass of the total epoxy resin;
requirement (3): the content of said component [C] is from 10 to 40 parts by mass, with respect to 100 parts by mass of the total epoxy resin;
requirement (4): said resin composition contains a total of 40 parts by mass or more of said component [B] and said component [C], in 100 parts by mass of the total epoxy resin; and
requirement (5): said resin composition does not contain a component [E] which is a glycidylamine type epoxy resin, or in cases where said resin composition contains said component [E], the content thereof is 10 parts by mass or less with respect to 100 parts by mass of the total epoxy resin.

2. The prepreg according to claim 1, wherein said resin composition does not contain said component [E], or in cases where said resin composition contains said component [E], the content thereof is 1 part by mass or less with respect to 100 parts by mass of the total epoxy resin.

3. The prepreg according to claim 1, wherein said resin composition further contains a component [F] which is a compound that has a boiling point of 130° C. or higher and a molecular weight m of 50 or more and 250 or less, that does not contain an epoxy group within the molecule, and that does not have an epoxy resin curing ability.

4. The prepreg according to claim 1, wherein said resin composition contains a component [G] which is a phenoxy resin, as a thermoplastic resin.

5. A fiber-reinforced composite material, obtained by curing the prepreg according to claim 1.

6. A tubular fiber-reinforced composite material, obtained by molding the prepreg according to claim 1.

7. A golf club shaft using the tubular fiber-reinforced composite material according to claim 6.

8. A fishing rod using the tubular fiber-reinforced composite material according to claim 6.
